(19) United States
(12) Patent Application Publication
(10) Pub. No.: US 2009/0204529 A1
(43) Pub. Date: Aug. 13, 2009

(54) Advanced Budget Bill Control System For End Users

(76) Inventors: Rand Warsaw, Monroeville, PA (US); Andy Meyer, Pittsburgh, PA (US); Joyce Homiak, Pittsburgh, PA (US)

Correspondence Address: FOX ROTHSCHILD, LLP;Pittsburgh, 2000 Market Street, 10th Floor, Philadelphia, PA, 19103, US

(21) Appl. No.: 12/347,117

(22) Filed: Dec. 31, 2008

Related U.S. Application Data
(60) Provisional application No. 61/018,659, filed on Jan. 2, 2008.

(51) Int. Cl. G06Q 40/00; G06N 5/02

(52) U.S. Cl. 705/35; 706/52

(57) ABSTRACT

A system and method for allowing a consumer of a commodity to set the parameters of a budget bill calculation system via an interactive user interface. The parameters are intended to help consumers control their budget bill calculations, payment structure, true-up factors and other aspects of their budget bills. Budget bill payment amounts are calculated based on historic weather patterns, previous consumption, previous bills, mathematical models or may be set by the consumer art a certain amount, and the parameters selected by the consumer. A budget payment amount is then presented to the user including a budget payment amount and, in some cases, an actual or estimated true-up amount including when and how ant recalculations of the budget amount and true-ups will take place.

### RELATED APPLICATIONS

This application claims the benefit of U.S. Provisional Application Ser. No. 61/018,659, filed Jan. 2, 2008 and entitled “Advanced Budget Bill Control System for End Users”.

### FIELD OF THE INVENTION

The invention relates to an advanced budget bill calculation method and system, and, more particularly, to a system in which end users are able to set their own parameters for various aspects of the system via a web-based or other type of user interface. The method and system is particularly useful with respect to energy and other types of commodities, to offer end users various choices beyond simple selections of a plan type.

### BACKGROUND OF THE INVENTION

Many distributors and mass marketers of commodities, such as water, heating oil, propane, electricity and natural gas, offer consumers leveled payment options, typically referred to as budget bills. Consumers rely on these plans to facilitate budgeting by allowing them to pay a set amount each month. These programs are all designed to periodically adjust (one or more times each year) with a special consumer balance payment or credit referred to commonly as a “true-up”, or an arrangement to periodically adjust the level of the bill to spread the true-up forward over multiple periods.

Recently, more advanced products, known as fixed bills, have been introduced. Fixed bill programs are basically budget bills without the true-up aspect. A premium is typically charged to consumers which can be used to offset the risk required to remove the true-ups in fixed bill products. Some consumers are often unhappy with premiums for fixed bills, lack of options for budget bills, and the volatile nature of budget bill calculations that can lead to unexpected payments for true-ups. The unexpected true-up payments frequently cause consumer financial stress, leading to arrearages.

### SUMMARY OF THE INVENTION

The present invention provides a system and method which allows a consumer of energy or other commodities, or their representatives, to enter commands into a visual-front-end to control and customize various components or all aspects of their budget bill. One aspect of the present invention permits the user to choose how the budget bill payment or components of the payment are determined or calculated. Another aspect of the present invention would allow the user to choose how the budget bill payments or individual components of the payment are to be structured over time or composition. These options may be offered to the user in any combination and the user is not limited to having choices regarding only these options.

The consumer is not required to have a detailed knowledge of the distributor or mass marketers' databases or systems, and can access this invention using an interface such as the web or other computer application, or through email, letter or a telephone communication with an agent such as a customer service representative of a distributor using the invention in place of the consumer. Individual or group options can be set by the distributor or mass marketer based on, for example providing different choices based on consumer credit and their desire to control consumer options.

### BRIEF DESCRIPTION OF THE DRAWINGS

FIG. 1 shows a schematic overview of one embodiment of the system of the present invention.

FIG. 2 is a data flow diagram for one possible embodiment of the system of the present invention.

FIG. 3 is a sample interface page showing current budget bill status.

FIG. 4 is a sample interface page showing customer history related to the true-up.

FIG. 5 is a sample interface page on which the user can request an immediate recalculation of the budget bill to forward allocate historic true-ups into future budget bill amounts.

FIG. 6 is a sample interface page on which the user can request a periodic recalculation of the budget bill to forward allocate historic true-ups into future budget bill amounts.

FIG. 7 is a sample interface page showing various options that the user can select.

FIG. 8 is a sample interface page showing the option wherein the customer may specify the budget payment amounts.

### DETAILED DESCRIPTION OF THE INVENTION

The invention is best understood from the following detailed description when read with the accompanying drawings.

The present invention provides interfaces and methods which allow a user, which can be a consumer or a third party acting in the consumer's interest, such as a customer service representative, of a vendor of an energy or other commodity, to enter commands into a visual front end to control various key aspects of the consumer's budget bill such as components of the payment, payment amounts or portions thereof, timing of the payments or portions thereof.

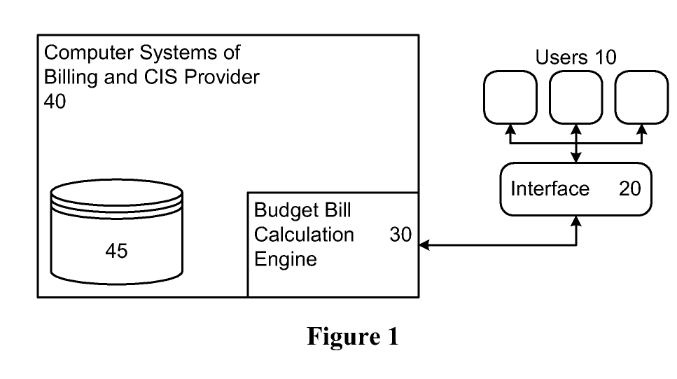

FIG. 1 shows a schematic overview of one embodiment of the system. Users 10 use an interface 20, such as a web interface or a software application, which provides a visual interface, with which users 10 can interact and use to control the specific parameters used by budget bill calculation engine 30 to calculate the components of consumer's budget bill amount. Budget bill calculation engine 30 is a high level component responsible for calculating the budget bill payment amount, as well as the structure and timing of the payments. Budget bill calculation engine 30 also enforces any limitations set by the commodity supplier. Budget bill calculation engine 30 uses data from computer systems 40 of the commodity supplier which contains, for example, consumer-specific consumption information, and other databases containing other relevant data, for instance, historic weather-related information, to calculate budget bill amounts, which are returned to the consumers 10 via the interface 20.

The budget bill payment amount may be composed of various components, including for example, true-up amounts from prior account balances, estimated or actual current period charges and anticipated charges over a future period. Additionally, there is a structural component of the payment amount allowing the user to specify how often payments are made and to defer or advance payments for convenience.

The current period charges may also include estimates of weather and consumption or actual billed values for the current billing period. The estimate of anticipated charges, may include, for example, estimates of commodity or energy costs, distribution costs, fuel cost adjustment or purchased gas adjustment, rider adjustments, taxes, franchise fees, other surcharges, storm damage recovery, and voluntary donations.

Additional components of the budget bill payment amount may include charges for items not typically related to the core business of commodity supplying, such as, leasing costs (furnace, appliances etc), equipment sales, insurance, service line replacement, internet services, broadband or telecommunications charges, and smart equipment costs.

Users 10 use interface 20 to control the specifics of a budget bill calculation engine 30. Users 10 can view the current status of their budget bill calculations. Users 10 not currently enrolled in a budget program can use interface 20 to determine the many ways in which their budget bills would be or could be calculated should they enroll in a budget bill program. Users 10 may also enroll in the program from this interface 20.

Interface 20 can be implemented as a web page or other interface running on a server or as a software application which is downloaded to the computer of each user 10 and run locally. To fully benefit from the on-line capabilities of the system, user 10 will need a computer having a network connection such as an Internet connection or other connection such as a direct dial-in portal (not shown).

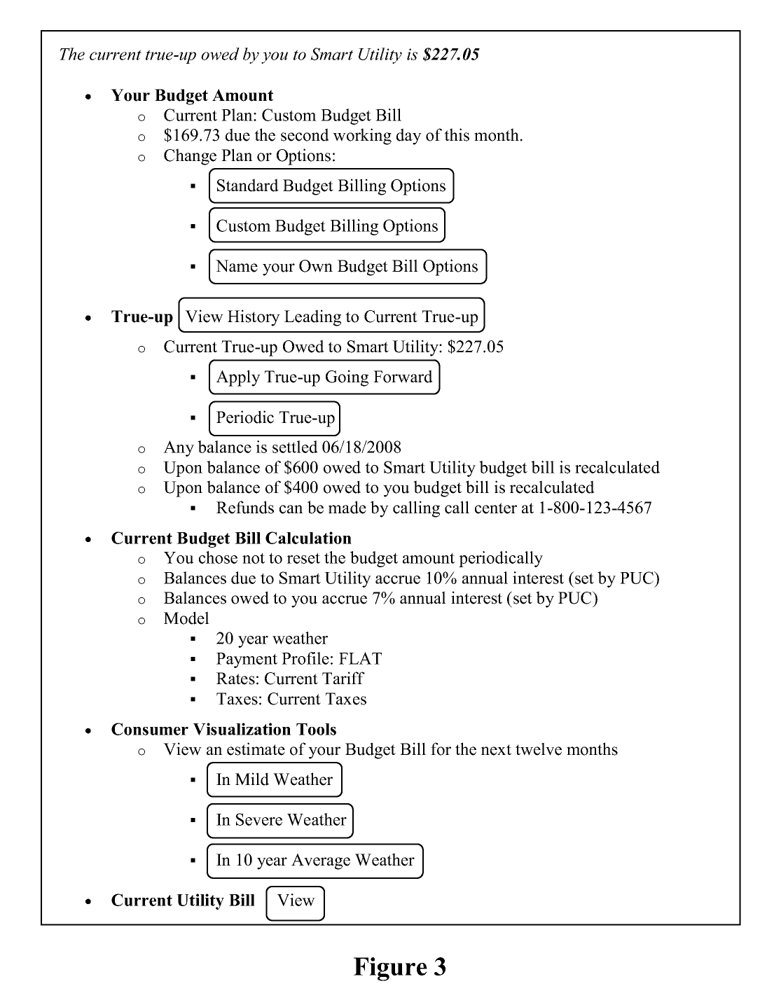

In operation, the present invention allows commands entered into interface 20 to control how the budget bill payment amount is determined or calculated and how the budget payments are to be structured. FIG. 3 shows the flow of data in a typical implementation of the system. Users 10 supply instructions via interface 20. Interface 20 passes the instructions 210 to budget bill calculation engine 30, which consists of three logical functional units, payment structure engine 330, true-up calculation engine 320 and forward modeling engine 310. Data 210 is passed in a format required by the budget bill calculation engine 30, and may optionally be encrypted to preserve the security of the transaction.

FIG. 3 shows a sample customer detailed status page. Security to control access may optionally be invoked. For instance, this page may be reached after a user 10 has been appropriately identified and authenticated, by, for example, having typed in a pre-supplied username and password. Optionally, users 10 may also be able to set up accounts on-line by creating an account and identifying themselves via account number or other information obtainable from, for example, their most recent billing statement. This page shows the current budget bill payment amount and the currently-owed accumulated true-up amount. From this page, users 10 may be given the option to change their plan or plan options.

For example, user 10 may select among numerous options, the standard budget billing options, which may include, for example, the options of calculating the budget bill amount once per year and adjusting every month for true-up within a 12 month spread, calculating the budget bill amount once per year and adjusting every quarter for true-up within a 12 month spread or recalculating the budget bill amount every year.

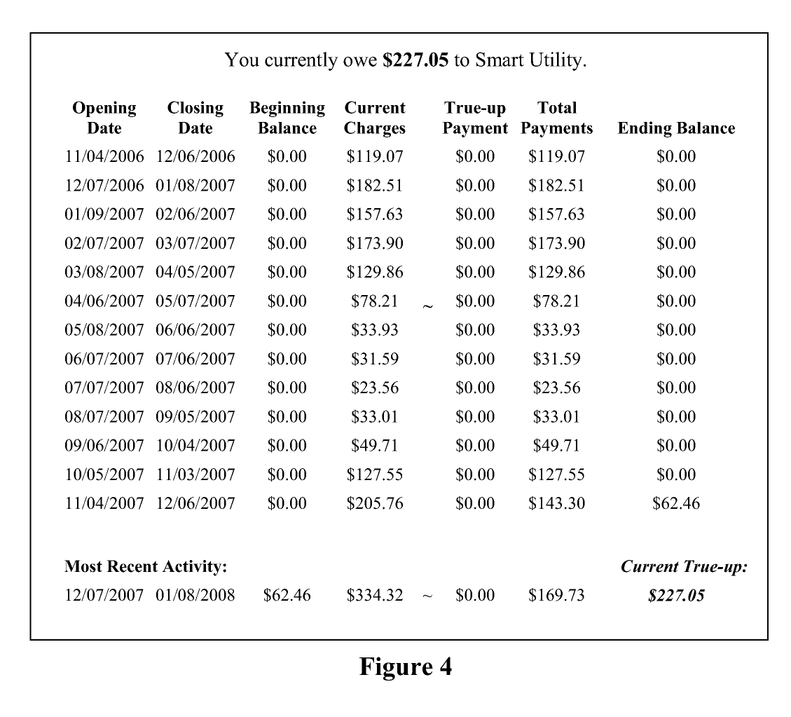

User 10 may also be provided the opportunity, in this example, from the status screen of FIG. 4, to select custom budget billing options. These may include, for example, the time period between recalculations of the budget bill, whether to calculate the budget amount based on historic weather averages (and the time period over which to average the historic weather data) or on the consumer's consumption during the past year, the payment profile, being flat (same payment every month) or customized in some manner to take into seasonal variations, a provision for adding anticipated taxes into the budget bill payment amount, a way to adjust the rates charged by the provider and to adjust for commodity price. Numerous other options may also be available.

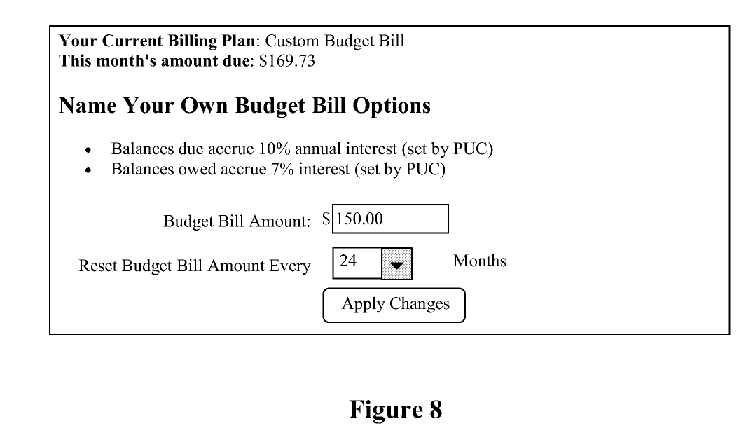

Lastly, user 10 may be provided the opportunity to select a “name your own payment option” in which the monthly payment may be set by the user. See FIG. 8 for an example of a user interface screen wherein the user can specify the parameters for the name your own payment option. Note that the amount of the true-up component may be limited and as such, may place a downward limit on the periodic budget bill payment amount proposed by the user.

Note that it is not anticipated that every user 10 will be provided every possible option. Certain options may be fixed or unalterable for certain groups of consumers, or may be restricted as the result of parameters set by a particular commodity provider for their particular implementation of the program or by, for example, the consumer's ability to be granted credit for the accumulated true-up amount.

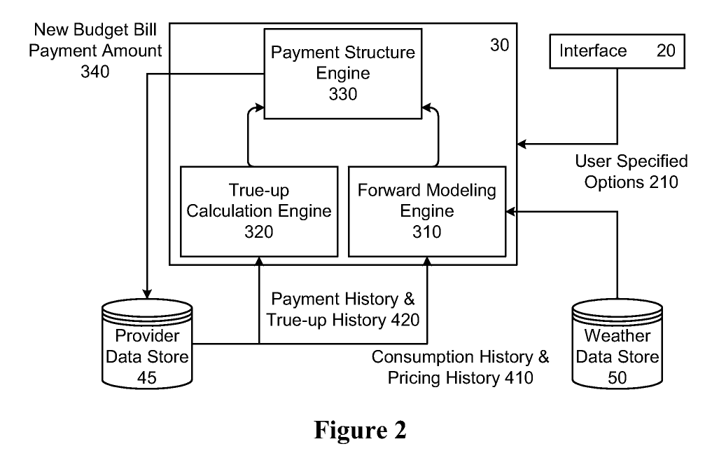

Interface 20 collects the user's options and communicates the options to budget bill calculation engine 30. FIG. 2 shows an implementation of budget bill calculation engine 30. It should be realized by one of skill in the art that the functional aspects of budget bill calculation engine 30 may be logically grouped in any manner and that FIG. 2 shows only one possible embodiment.

Forward modeling engine 310 produces the estimate of the anticipated charges component of the budget bill payment amount. The estimate may be based on information stored in the provider's data stores 45 on computer systems 40, such as consumption and payment history 410 of the particular consumer and on information regarding historical weather, stored in database 50, which may be local to provider's computer system 40 or which may be remotely accessible and provided by a third party. Such information may be supplied to forward modeling engine 310 either periodically or on an as-requested basis.

True-up calculation engine 320 produces a calculation of amounts owed or credits due from previous and current billing periods. True-up calculation engine 320 may require information regarding payments previously made by the consumer and charges to consumer's account provided from database 45.

Payment structure engine 330 schedules payments due based on the options selected by user 10, the true-up component calculated by true-up calculation engine 320, and the anticipated charges component produced by forward modeling engine 310. The timing and amounts of budget bill payments for future periods is set by payment structure engine 330. For example, user 10 could select eleven equal monthly payments due on the first of each month, with balance at the end of the eleventh month spread over the twelfth and thirteenth months. It should be obvious that many other combinations are possible.

Budget bill calculation engine 30 may also be provided with a data store (not shown) for the storage of audit trails for the calculations. This storage could be located within the provider's data store 45 or separately with the budget bill calculation engine 30. Such storage may also be used to retain values and amounts applied over more than one future period. Alternatively, instructions for the new budget bill payment amount 340 can contain this information.

The consumption history and pricing information 410 and the payment history & true-up history 420 are also shown being delivered to the forward modeling engine 310 and the true-up calculation engine 320 upon demand or periodically as scheduled. Based on the user specified options 210, the budget bill calculation engine 30 coordinates payment structure engine 330, true-up calculation engine 320 and forward modeling engine 310 to generate a new budget amount 340 which is returned to the computer systems 40 of the commodity marketer or distribution provider.

Ultimately, the consumer is presented with a program of required payments which may include the periodic budget bill payment amount (which may include payoffs for accumulated true-ups from previous billing periods), calculated by payment structure engine 330.

User 10 may be provided the option of running calculations with different parameters to see how the budget bill payment amounts are affected by the parameters chosen by the user, and what the likely account balances would be under varying scenarios such as calculating sample bills based on a historic year's weather data and varying prices or on speculative data for the coming year. User 10 can then compare the various scenarios prior to selecting the desired settings.

Once the consumer has settled on a particular set of parameters, the new budget amount 340 is stored in the provider's data store 45.

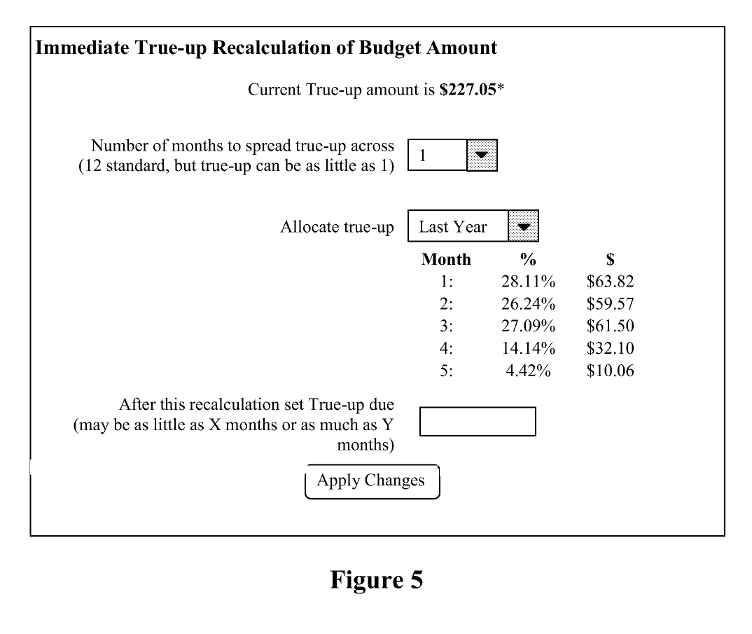

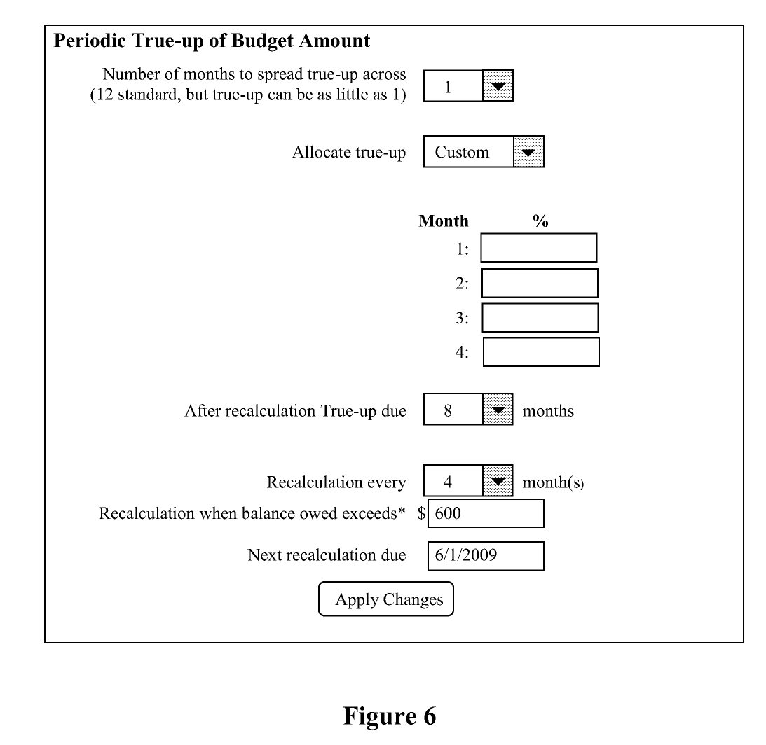

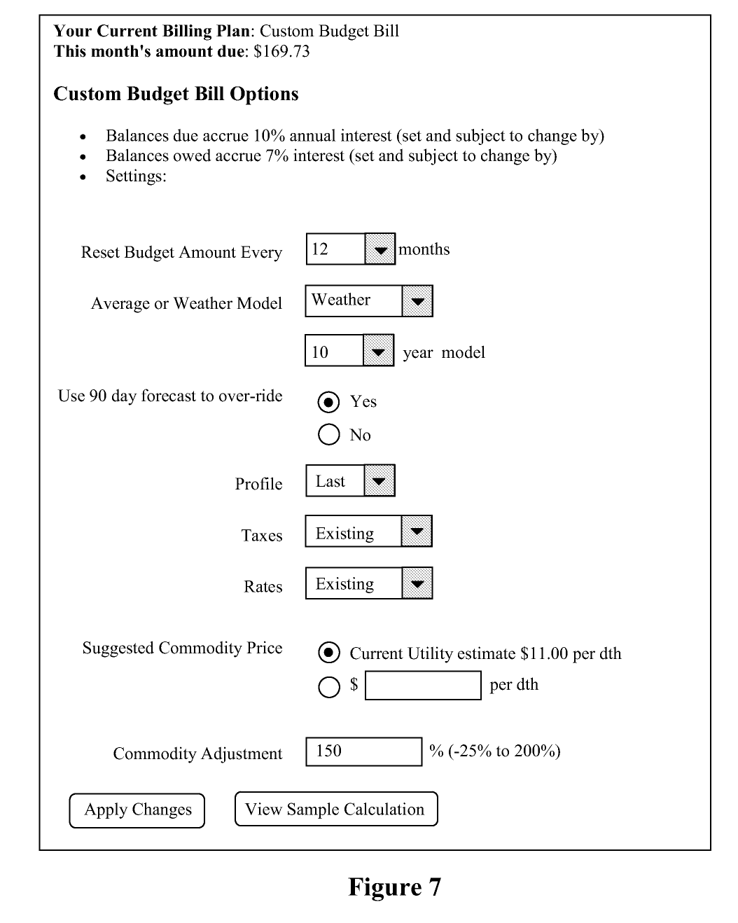

FIGS. 4-8 show samples of the pages of interface 20 which allow user 10 to customize the budget plan to suit the consumer's particular needs. Options offered can be the same for each consumer, or can vary at the provider's discretion based on any number of parameters. Customer specific credit history is one example of a parameter where the provider may restrict differing options.

Also included in the system, but not shown in the figures, is a help feature that provides a description of the various options and the effects they are likely to have on the end user's monthly bill.

It is easily recognized by one of skill in the art that the implementation presented is only one example, and that many logical, functional and physical variations could be made while still providing the same functionality. For example, all or portions of interface 20, all or portions of calculation engine 30, as well as all or portions of the database 45 and database 50 (shown in FIG. 3), can also be distributed within the computer or computer systems of consumer 10, or on other, third party computer systems. In addition, database 45 and database 50 can reside in the same database as tables, or be separated into completely separate databases. Communications between the computer system of consumer 10 and computer systems 40 of the provider may be via any known method of communication, but will preferably be via data transfer using the Internet or other local or wide area network.

Sample screens have been included in the figures, but in an actual application, as would be recognized by one of skill in the art, there are unlimited arrangements of screens and data input methods that could be used while still providing the same functionality. Additionally, pre-computation on a centralized computer of numerous options and parameters to offer the consumer may be performed. These options will be selected via a consumer interface mimicking the functionality of systems described here. With modern day networking, any of the components may reside in any physical or virtual system. FIGS. 1 through 8 show the current best mode regarding configuration, however the important concept is that consumers have choices in the components of the budget bill, the true-ups and the payment structures rather than a choice of one or two fixed parameter programs offered in one size fits all fashion.

We claim:

1. A method for allowing an individual user to customize a consumer's budget payment plan for a commodity comprising the steps of:
a. providing a user interface displayed on a computer, said user interface having one or more user-selectable parameters listed thereon;
b. allowing said user to specify one or more of said user-selectable parameters;
c. calculating one or more budget payments for a pre-determined period of time, said budget payments being dependent upon said user-selectable parameters specified by said user; and
d. presenting the budget payments to the user.

2. The method of claim 1 wherein said calculation step further comprises the step of utilizing an estimate of consumption of the commodity during said pre-determined period of time as a factor in calculating said one or more budget payments.

3. The method of claim 2 wherein said estimate of consumption is based on one or more of said user-selectable parameters selected from a group consisting of utilizing an analytic consumption model using typical consumption and corresponding weather, utilizing a user-specified amount of said commodity and utilizing an analytic consumption model driven by historic consumption of said user and corresponding weather.

4. The method of claim 3 wherein said estimate of consumption utilizes an analytic model, said analytic model being selected from a group consisting of a normalized weather and consumption model, a weather model predictive of milder than normal weather during said pre-determined time period and a weather model predictive of harsher than normal weather during said pre-determined time period.

5. The method of claim 3 wherein said estimate of consumption utilizes an adder or a multiplier of the historic consumption of said user.

6. The method of claim 1 wherein said budget payment amount includes one or more components selected from a group consisting of current charges, anticipated charges and true-up charges and further wherein said calculation step further comprises the step of utilizing an estimate of costs of said components during said pre-determined period of time as a factor in calculating said one or more budget payments.

7. The method of claim 6 wherein said estimate of costs is based on one or more of said user-selectable parameters selected from a group consisting of utilizing an analytic cost model using typical costs and corresponding weather, utilizing a user-specified amount of said costs and utilizing an analytic cost model driven by historic costs of said user and corresponding weather.

8. The method of claim 7 wherein said estimate of costs utilizes an analytic model, said analytic model being selected from a group consisting of a normalized weather and cost model, a weather model predictive of milder than normal weather during said pre-determined time period and a weather model predictive of harsher than normal weather during said pre-determined time period.

9. The method of claim 7 wherein said estimate of cost utilizes an adder or multiplier of the historic costs of said user.

10. The method of claim 1 wherein said calculation step further comprises the step of utilizing any accumulated balance or credit due from a previous billing period as a factor in calculating said one or more budget payments.

11. The method of claim 10 wherein said calculation of said one or more budget payments may include an interest component for any accumulated balance or credit due.

12. The method of claim 1 wherein said calculation step further comprises the step of utilizing user-specified timing and profile options as a factor in calculating said one or more budget payments.

13. The method of claim 12 wherein said user specifies the number of budget payments for said pre-determined period of time.

14. The method of claim 13 wherein said user specifies the timing of said one or more budget payments for said pre-determined time period.

15. The method of claim 12 wherein said user specifies a flat payment profile wherein the amounts of each of said one or more budget payments are the same.

16. The method of claim 12 wherein said user specifies a varying payment profile in which the amounts of said one or more budget payments differ.

17. The method of claim 12 wherein said calculation step further comprises the step of utilizing any accumulated balance or credit due from a previous billing period as a factor in calculating said one or more budget payments.

18. The method of claim 12 wherein said calculation step further comprises the step of utilizing an estimate of consumption or cost of said commodity during said pre-determined period of time as a factor in calculating said one or more budget payments.

19. The method of claim 18 further comprising the step of calculating an estimated true-up amount for said pre-determined time period, based on said estimate of cost or consumption of said commodity and said user-specified timing and profile options.

20. The method of claim 12 wherein said user-selectable parameters give the user the ability to specify the amounts of said one or more budget payments.

21. The method of claim 20 wherein said user-specified amounts may be limited based on a maximum allowable estimated true-up amount.

22. The method of claim 12 further comprising the step of calculating a true-up amount based on the difference between the cost of the user's actual consumption and said one or more budget payments.

23. The method of claim 22 wherein said user can specify periodic recalculations of said one or more budget payments, further comprising the step of periodically recalculating said one or more budget payments and including said calculated true-up amount as a factor in said one or more recalculated budget payments.

24. The method of claim 1 further comprising the step of limiting or forcing said one or more budget payments based on restrictions put in place by the provider of said commodity selected from a group consisting of the user's credit, the user's current balance, the user's payment history, regulatory requirements and a limitation on the estimated true-up amount.

25. The method of claim 1 wherein said user-selectable parameters include whether or not to include estimated or actual taxes and surcharges in said budget payments.

26. The method of claim 1 wherein said user is provided several scenarios based on differing sets of user-specified parameters, such that said user can compare the estimated budget payment amounts and schedule of payments for various scenarios.

27. A method for allowing an individual user to customize a consumer's budget payment plan for a commodity comprising the steps of:
a. providing a user interface displayed on a computer, said user interface having one or more user-selectable parameters listed thereon;
b. allowing said user to specify one or more of said user-selectable parameters;
c. utilizing a user-specified model to estimate of consumption or cost of the commodity during said pre-determined period of time as a factor in calculating said one or more budget payments;
d. utilizing any accumulated balance or credit due from a previous billing period as a factor in calculating said one or more budget payments, said user specifying how said accumulated balance or credit due is to be factored into said one or more budget payments;
e. utilizing user-specified timing and profile options as a factor in calculating said one or more budget payments.
f. calculating one or more budget payments for a pre-determined period of time; and
g. presenting the budget payments to the user via said user interface.

28. A system for allowing a user to customize a budget billing plan for a commodity comprising:
a. a user interface, displayed on a user's computer, said user interface having user-selectable parameters listed thereon;
b. a database containing historic data; and
c. a budget bill calculation engine, running on a computer, for calculating one or more budget payments based on parameters specified by said user using said user interface and on said data stored in said database.

29. The system of claim 28 wherein said database contains data selected from a group consisting of historic weather data and data regarding past consumption of said commodity by said user and payments made by said user.

30. The system of claim 28 wherein said budget bill calculation engine further comprises:
a. a forward modeling engine, for calculating an estimate of the user's future consumption of said commodity for a pre-determined period of time;
b. a true-up calculation engine for calculating accumulated true-up amounts; and
c. a payment structure engine, for calculating the timing and amounts of said one or more budget payments.

31. The system of claim 30 wherein said estimate of future consumption is based on one or more of said user-selectable parameters selected from a group consisting of utilizing an analytic consumption model using typical consumption and corresponding weather, utilizing a user-specified amount of said commodity and utilizing an analytic consumption model driven by historic consumption of said user and corresponding weather.

32. The method of claim 31 wherein said estimate of future consumption utilizes an analytic model, said analytic model being selected from a group consisting of a normalized weather and consumption model, a weather model predictive of milder than normal weather during said pre-determined time period and a weather model predictive of harsher than normal weather during said pre-determined time period.

33. The method of claim 31 wherein said estimate of future consumption utilizes an adder or a multiplier of the historic consumption of said user.

34. The method of claim 30 wherein said estimate of future consumption is based on the cost of said commodity.

35. The method of claim 30 wherein an interest charge is factored into said calculation of said true-up amount.

36. The method of claim 30 wherein said calculation of said one or more budget payments further comprises utilizing user-specified timing and profile options as a factor in calculating said timing and amounts of said one or more budget payments.

37. The method of claim 36 wherein said user specifies the number of budget payments for said pre-determined period of time.

38. The method of claim 36 wherein said user specifies the timing of said one or more budget payments for said pre-determined time period.

39. The method of claim 36 wherein said user specifies a flat payment profile wherein the amounts of each of said one or more budget payments are the same.

40. The method of claim 36 wherein said user specifies a varying payment profile in which the amounts of said one or more budget payments differ.

41. The method of claim 30 wherein an estimated true-up amount for said pre-determined time period is calculated, based on said estimate of consumption of said commodity and said user-specified timing and profile options.

42. The method of claim 30 wherein said user-selectable parameters give the user the ability to specify the amounts of each of said one or more budget payments.

43. The method of claim 42 wherein said user-specified amounts may be limited based on a maximum allowable estimated true-up amount.

44. The system of claim 28 wherein said user interface is a web page served to said user's computer.

45. The system of claim 28 wherein said user interface is a software application running on said user's computer.

46. The system of claim 28 wherein said budget bill calculation engine is running on a computer remote from said user's computer and further wherein said user's computer and said remote computer can exchange data with each other.

47. The system of claim 46 wherein said exchange of data happens over the Internet.
